(19) United States
(12) Patent Application Publication
(10) Pub. No.: US 2003/0150085 A1
(43) Pub. Date: Aug. 14, 2003

(54) Manipulation of solvent properties for particle formation

(76) Inventors: Lalit Chordia, Pittsburgh, PA (US); Poongunran Muthukumaran, Pittsburgh, PA (US)

Correspondence Address: POONGUNRAN MUTHUKUMARAN, THAR TECHNOLOGIES, INC., 730 WILLIAM PITT WAY, PITTSBURGH, PA, 15238, US

(21) Appl. No.: 10/361,553

(22) Filed: Feb. 6, 2003

Related U.S. Application Data
(60) Provisional application No. 60/355,247, filed on Feb. 8, 2002.

(51) Int. Cl. B01D 9/00

(52) U.S. Cl. 23/295 R

(57) ABSTRACT

Present invention provides method and apparatus to produce fine particles of a desired substance utilizing antisolvent precipitation technique. It further provides ways to manipulate the solvent and antisolvent to obtain fine particles of desired characteristics.

### CROSS-REFERENCE TO RELATED APPLICATION

This application claims benefit from the Provisional patent application Serial No. 60/355,247 and entitled UTILIZATION OF SOLVENT PROPERTIES FOR PARTICLE FORMATION, teachings of which are incorporated herein by reference.

### BACKGROUND OF THE INVENTION

1. Field of Invention

The current invention relates to a method for the production of fine particles in the micro- to nanometer range utilizing antisolvent precipitation. The invention also provides means for particle coating or encapsulation using the same technique.

2. Background and Prior Art

The formation of fine particles of desired substances in the micro- to nanometer range is an intense area of research. The processes and methods can be extended to a wide variety of materials, including catalysts, chemicals, coatings, explosives, pesticides, polymers and pharmaceuticals. Many supercritical fluid processes have been used to produce fine particles. Rapid Expansion of Supercritical Solutions (RESS) has been successful however this technique does have certain disadvantages, such as solubility issues and substantial pressure drops, which can be quite costly. Supercritical antisolvent processes (SAS) are an alternative method in which fine particles can be formed. The solute is dissolved in a solvent and sprayed into another solvent in which the solute is insoluble. The result is the precipitation of particles. Typically, the solvent is a liquid organic solvent however this invention will focus on gaseous substances for both the solvent and antisolvent in this process. Building on this concept, SAS-EM can add energy to the SAS process to enhance atomization of the dispersion, mass transfer rate of the antisolvent into the droplet and the solvent out of the droplet through the use of a vibrating surface to atomize the solution jet. SAS-EM has an external variable to control the atomization. A change in the amplitude of vibrations changes the atomization without affecting system composition. This gives complete flexibility to manipulate the composition of the system for optimization and still obtain enhanced atomization.

There has been much work performed in the field of supercritical fluid particle technology starting with Krukonis et al. in 1984. Most of the research has focused on using either RESS or SAS. Some examples of the particles formed using these techniques include steroids (Larson and King, 1985), polystyrene (Dixon et al., 1993), trypsin (Winter et al., 1993) and insulin (Yeo et al., 1993; Winter et al., 1993). Other work has focused on the formation of fine polymeric particles that contain various drugs for the purpose of controlled drug release (Tom et al., 1992; Mueller and Fischer, 1989). The Debenedetti European Patent Application No. 92119498.1 discloses the formation of protein microparticles using antisolvent precipitation. Schmitt (PCT publication WO 90/03782) disclosed the use of antisolvent precipitation for the formation of finely divided solid crystalline powders. Hanna and York (U.S. Pat. No. 6,063,138) also disclosed a method and apparatus for the formation of particles of given substances using supercritical fluids.

While much research has been performed, SAS can still only be used to produce particles in the 1-10 μm range, which is not applicable for pharmaceuticals. Therefore, attempts at adjusting the SAS process have been made in order to address this issue. For example, the use of a coaxial nozzle (PCT publication WO 95/01221) was employed to co-introduce the supercritical fluid and solution, allowing for better atomization of the solution jet. Randolph et al. (1993) used an ultrasonic nozzle in the SAS process, and this concept was disclosed in U.S. Pat. Nos. 5,833,891 and 5,874,029. The technique was then expanded (U.S. patent application US 2002/0000681 A1) by employing a vibrating surface in order to atomize the jet into microdroplets and provide a narrow size distribution.

It is clear from these examples that while methods exist for particle formation using supercritical fluids, there is still a vast research area yet to be explored for improving upon current techniques, such as elimination of organic solvents from the process altogether. Therefore, the intention of this invention is to address some of these issues.

### SUMMARY OF THE INVENTION

The present invention provides a novel means to manufacture fine particles of a desired substance in the micro- to nanometer range with a narrow size distribution utilizing antisolvent-precipitation processes. The processes and methods involved in the invention can be used for producing micro- and nanoparticles of a wide variety of materials, including catalysts, chemicals, coatings, explosives, pesticides, polymers and pharmaceuticals.

Typically, a desired substance is dissolved in a solvent and brought in contact with an antisolvent which is miscible with the chosen solvent. The antisolvent extracts the solvent and precipitates the desired substance as fine particles. Subsequent removal of the residual solvent from the particles is an additional step involved in conventional antisolvent precipitation processes. When a supercritical fluid is used as the antisolvent, removal of residual solvent becomes easier as further purging of the particles with the antisolvent ensures low residual solvent levels.

The present invention provides an improved method where a subsequent purging step may be short or not needed at all. When pressure and temperature manipulated solvents are used, they can dissolve a significant amount of the desired substance in them and subsequent contact with the antisolvent precipitates the desired substance. During the depressurizing step, such solvents become less bound to the particles either because they lose the solvating power or because they become gaseous in nature. This automatically ensures the removal of residual solvent from the particles of the desired substance. In addition, many new drug entities are not very soluble in solvents at ambient pressures and temperatures. They cannot be easily processed using an antisolvent precipitation method. Even if they can be processed using such a method, throughput will be too low to be economically viable. The present invention overcomes such problems and makes antisolvent precipitation processes industrially viable.

### BRIEF DESCRIPTION OF THE DRAWINGS

FIG. 1. Schematic Representation of Apparatus

FIG. 2. Schematic Representation of Apparatus with Additional Energy

### DETAILED DESCRIPTION OF THE INVENTION

### Definitions

“Manipulated solvent” means

A solvent whose pressure and temperature are manipulated.

“Desired substance” means

The material comprising of one or more substances of interest. This includes but not limited to catalysts, chemicals, coatings, explosives, pesticides, polymers, and pharmaceuticals.

“Desired solvent” means

A solvent or combination of solvents chosen to be used.

“Antisolvent” means

A fluid or combination of fluids that does not substantially dissolve the desired substance and reasonably miscible with the solvent.

“Manipulated antisolvent” means

An antisolvent that is pressure and temperature manipulated.

“Piezoelectric” means

A material capable of generating vibrations when subjected to applied voltage.

“Magnetorestrictive” means

A material capable of generating vibrations when subjected to a change in its state of magnetization.

“Supercritical” means

A condition that is above the critical temperature and critical pressure of a fluid or a mixture of fluids.

“Dispersion” means

A homogeneous or a heterogeneous mixture of the desired substance in one or more suitable solvents with or without dispersants or coreparticles.

“Nozzle” means

A device to apply or spray the dispersion.

“Batch mode” means

Performing a process with inputs and outputs transferred intermittently.

“Semi-continuous mode” means

Performing a process with either one of the inputs or outputs transferred continuously.

“Continuous mode” means

Performing a process with more than one of the inputs or outputs transferred continuously.

“Desired pressure” means

A pressure advantageous for a specified task.

“Desired temperature” means

A temperature advantageous for a specified task.

“Morphology” means

A physical morphology, crystalline morphology, or crystalline structure of the solid material.

### Description

The present invention provides a novel means to manufacture fine particles of a desired substance in the micro- to nanometer range with a narrow size distribution utilizing antisolvent processes. The processes and methods involved in the invention can be used for producing micro- and nanoparticles of a wide variety of materials, including catalysts, chemicals, coatings, explosives, pesticides, polymers and pharmaceuticals.

In this process, a substance with minimal solubility in a desired solvent at ambient conditions but with solvating power to dissolve said substance under manipulation of pressure and temperature is used. Typically, said solvents are gaseous in nature at atmospheric pressure and ambient temperatures. Solvent choice may include, but not limited to methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride, or a combination thereof. The desired substance has low solubility in the antisolvent at both ambient conditions and manipulated pressures and temperatures. The manipulated solvent is reasonably miscible with the said manipulated antisolvent. Antisolvent choice may include, but not limited to methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride, or a combination thereof. Sufficient manipulation of pressure and temperature for said solvent and antisolvent typically occurs near or above their respective critical points. However, it can also be lower in certain instances.

The desired substance is dissolved in said manipulated solvent. Next, the resultant dispersion is sprayed through a nozzle into a chamber containing manipulated antisolvent. Manipulated antisolvent in the chamber expands the dispersion, dissolves the solvent and precipitates the desired substance in the form of fine particles. Particle precipitation and/or collection can be carried out in batch, semi-continuous or continuous mode.

A cleaning step after the precipitation step helps to completely remove the solvent from the particles. The manipulated antisolvent is diffused through the collected particles for a desired amount of time to reduce residual solvent levels below regulatory limits. However, the present invention may reduce the duration of the cleaning step or eliminate it altogether.

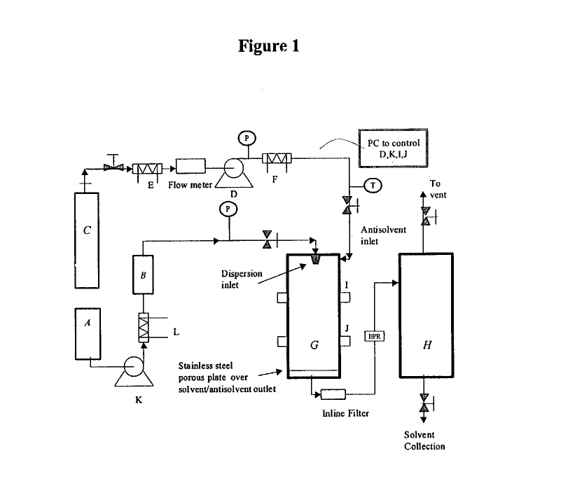

A schematic representation of the apparatus to be used for particle production according to the invention is shown in FIG. 1. Pump D is used to flow the antisolvent at a desired flow rate. The antisolvent stream is pumped through an individual temperature controlled zone F into particle production vessel G. Vessel G is maintained at a desired pressure and desired temperature (near and above the critical point of the antisolvent). The antisolvent inlet is located near the top of the vessel and the antisolvent outlet is located at the bottom of the vessel. Temperature and pressure sensors are employed accordingly at various locations.

Desired substance is contained in vessel B. Pump K is used to flow the desired solvent through an individual temperature controlled zone L into vessel B where it dissolves the desired substance. The resultant dispersion enters vessel G via a nozzle at a desired flow rate. Vessel G contains a stagnant or flowing antisolvent manipulated according to the invention. Said manipulated antisolvent precipitates the dispersion as fine particles and extracts the solvent. Particles are collected from vessel G on or in a filter element at the antisolvent/solvent outlet, creating a single zone for precipitation and collection. Antisolvent/solvent mixture exits the vessel through the outlet and enters a back pressure regulator (BPR). Control of pressure is achieved through the BPR. Pressure is reduced after the BPR and the antisolvent/solvent mixture is separated. They can potentially be recycled. Pump D, Pump K, BPR and temperature controlled zones F and L are utilized for the manipulation of the antisolvent.

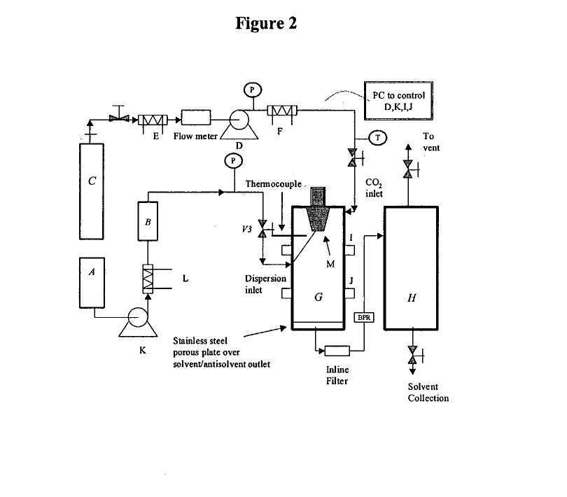

In another embodiment of this invention, vibration by piezoelectric or magnetorestrictive means may be used within the chamber to enhance the atomization of the dispersion, mass transfer rate of the antisolvent into the droplet and solvent out of the droplet. For such an embodiment, the apparatus shown in FIG. 2 is to be used. Pump D is used to flow the antisolvent at a desired flow rate. The antisolvent stream is pumped through an individual temperature controlled zone to maintain a desired temperature into vessel G. Vessel G is maintained at a desired pressure and a desired temperature. Temperature and pressure sensors are employed accordingly at various locations. The antisolvent inlet is located near the top of the vessel and the antisolvent outlet is located at the bottom of the vessel. Locations of the inlets and outlets are immaterial to the practice of the invention in all embodiments.

Pump K is used to flow a desired solvent through an individual temperature controlled zone L into vessel B where it dissolves the desired substance. The resultant dispersion is applied at an angle onto a vibrating surface M mounted from the top of the vessel at a desired flow rate. Particles are collected from vessel G on or in a filter element at the antisolvent/solvent outlet, creating a single zone for precipitation and collection. Antisolvent/solvent mixture exits the vessel through the outlet and enters a back pressure regulator (BPR). Control of pressure is achieved through the BPR. Pressure is reduced after the BPR and the antisolvent/solvent mixture is separated. They can potentially be recycled. Pump D, Pump K, BPR and temperature controlled zones F and L are utilized for the manipulation of the antisolvent and solvent.

In another embodiment of the invention, collection of particles is made continuous by moving the collection zone away from the precipitation zone. In such embodiment, the precipitation vessel is in fluid contact with the collection vessel through a valve mechanism. Particles are collected on or in a filter element in the collection vessel and the collection vessel can be isolated and purged with the manipulated antisolvent independently. Several such collection vessels and switching of the valve at the fluid connection between the precipitation vessel and the collection vessels allow for the collection of particles continuously in several batches.

In another embodiment of the invention, more than one desired substance can be processed according to the invention stated in the previous paragraphs where one or more substances can coat or encapsulate one or more substances.

We claim:

1. A method and apparatus for manufacture of particles of a desired substance comprising:
a. Using a solvent in which the desired substance has no or negligible solubility at ambient conditions.
b. Manipulating pressure and temperature of said solvent to increase the solubility of said desired substance.
c. Using an antisolvent such that:
1) Desired substance has minimal solubility in said antisolvent both at ambient and manipulated conditions.
2) Solvent is reasonably miscible with said antisolvent at manipulated conditions.
d. Applying a dispersion having at least a desired solvent and the desired substance into a vessel.
e. Applying an antisolvent at a high desired temperature and high desired pressure to the dispersion continuously.

2. The method as recited in claim 1 wherein the said solvent may be selected from the group consisting of methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride, or a combination thereof.

3. The method as recited in claim 1 wherein the antisolvent may be selected from the group consisting of methanol, ethanol, dimethylsulfoxide, tetrahydrofuran, N,N dimethylformamide, toluene, dichloromethane, ethyl ether, heptane, hexane, methylethylketone, methylisobutylketone, acetone, chloroform, fluoroform, carbon tetrachloride, cyclohexane, ethyl acetate, ethyl formate, isbutyl acetate, isopropyl acetate, 2-methyl-1 propanol, pentane, 1-pentanol, 1-propanol, and 2-propanol, ethane, propane, carbon dioxide, nitrous oxide, butane, isobutene, sulfur hexafluoride, or a combination thereof.

4. The method as recited in claim 1 wherein antisolvent may be recycled.

5. The method as recited in claim 1 wherein solvent may be recycled.

6. The method as recited in claim 1 including changing the morphology, size, shape and other properties of the particle by changing the concentration of the dispersion.

7. The method as recited in claim 6 wherein the change of concentration of the dispersion is accomplished through pressure and temperature manipulation of the solvent.

8. The method as recited in claim 1 including changing the morphology, size, shape and other properties of the particle by changing the flow rate of the solvent.

9. The method as recited in claim 1 including changing the morphology, size, shape and other properties of the particle by manipulating the pressure and temperature of the process.

10. The method as recited in claim 1 including changing the morphology, size, shape and other properties of the particle by changing the design and/or dimension of the nozzle.

11. The method as recited in claim 1 including changing the morphology, size, shape and other properties of the particle by adding energy to the process.

12. The method as recited in claim 11 wherein addition of the energy is through vibration.

13. The method as recited in claim 12 wherein the vibration is accomplished using piezoelectric or magnetorestrictive means.

14. The method as recited in claim 1 wherein one or more desired substances used to coat or encapsulate one or more desired substances.
